(19) United States
(12) Patent Application Publication
(10) Pub. No.: US 2021/0003167 A1
(43) Pub. Date: Jan. 7, 2021

(54) INSERT NUT

(71) Applicant: PSM IP LIMITED, Youngstown, OH (US)

(72) Inventor: Robert MANGAPORA, Canfield, OH (US)

(21) Appl. No.: 16/503,942

(22) Filed: Jul. 5, 2019

(51) Int. Cl. F16B 37/04

(52) U.S. Cl. CPC F16B 37/04

(57) ABSTRACT

A insert nut for mounting a fastener to a soft or malleable material is disclosed. The insert nut includes a flanged head having at least one flat and a pilot extending from the flanged head. The flat of the insert nut is configured to abut a flat in the soft or malleable material and thereby inhibit rotation. The insert nut includes at least one tab arranged on an end of the pilot. The at least one tab is configured to be deformed into the soft or malleable material and thereby inhibit backing out of the insert nut from the soft or malleable material.

### CROSS-REFERENCE TO RELATED APPLICATION

None.

### BACKGROUND

Numerous application involve anchoring a component to a soft or malleable material, such as plastic, but difficulties may arise when mounting the component directly to the soft or malleable material. Accordingly, insert nuts have been developed for providing metallic threads within the soft or malleable material, thereby strengthening attachment between component and the soft or malleable material. During use, however, existing insert nuts may fail by being pulled loose (i.e., backing out) from the soft or malleable material or rotating relative to the soft or malleable material. It may therefore be desirable to provide an insert nut that inhibits relative movement between the insert nut and the soft or malleable material.

### SUMMARY

Disclosed herein is an insert nut. The insert nut may be utilized in a variety of applications and, in one example, the insert nut is utilized in automobile applications. Thus, also disclosed herein is an insert nut assembly comprising an insert nut, a soft or malleable material component, and tooling configured to deform the insert nut into the soft or malleable material component. In some examples, the tooling is also configured to place or locate the insert nut within the soft or malleable material component.

In some examples, the present disclosure relates to an insert nut. The insert nut may include a body and a threaded bore extending through the body, wherein the body further comprises a flanged head having at least one flat; a pilot extending from a flange surface of the flanged head; and at least one tab arranged on an end of the pilot opposite from the flange surface, the at least one tab being deformable to inhibit backing out of the insert nut. In these examples, the end of the pilot defines a top surface and the at least one tab defines an upper tab surface that is angled relative to the top surface of the pilot, and in some such examples, the tab surface is oriented at an angle relative to the top surface of the pilot of between 0 and 22°. In some examples, a plurality of rings are provided around a lateral surface of the pilot. In some examples, the body further includes a chamfered bore extending from the threaded bore at the end of the pilot; and, in some such examples, the chamfered bore is configured to receive a fastener head such that the fastener head is flush with a component surface.

In other examples, the present disclosure relates to an insert nut assembly. The insert nut assembly may comprise a component having an upper side and a lower side, and a hole extending through the component from the upper side to the lower side; and an insert nut arrangable within the hole of the component, the insert nut further comprising: a flanged head having at least one flat arranged to engage a corresponding flat defined in the lower side of the component, a pilot extending from a shoulder of the flanged head, at least one tab arranged on an end of the pilot opposite from the shoulder, the at least one tab being deformable into the upper side of the component to inhibit backing out of the insert nut, and a threaded bore extending through the flanged head and the pilot.

In even other examples, the present disclosure relates to an insert nut assembly. The insert nut assembly may comprise a component having an upper side and a lower side, and a hole extending through the component from the upper side to the lower side; an insert nut arrangable within the hole of the component, the insert nut further comprising: a flanged head having at least one flat arranged to engage a corresponding flat defined in the lower side of the component, a pilot extending from a shoulder of the flanged head, at least one tab arranged on an end of the pilot opposite from the shoulder, and a threaded bore extending through the flanged head and the pilot; and tooling configured to deform the at least one tab of the insert nut into the upper side of the component to inhibit backing out of the insert nut.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is isometric view of an exemplary insert nut, according to one or more embodiments of the present disclosure.

FIG. 2 is a side view of the insert nut of FIG. 1.

FIG. 3 is a top view of the insert nut of FIG. 1.

FIG. 4 is an unassembled perspective view of a component configured to receive the insert nut of FIGS. 1-3.

FIG. 5 is an assembled perspective view of the component and the insert nut of FIG. 4 before deformation of the insert nut.

FIG. 6 is a cross-sectional side view of FIG. 5 taken along section line 6-6, wherein the nut is partially installed in the component before deformation of the tabs flush with the component surface.

FIG. 7 is a perspective view of the insert nut assembled and deformed within the component, and exemplary tooling utilized to assemble and deform the insert nut into the component, according to one or more embodiments of the present disclosure.

FIG. 8 is a side view of component and the insert nut arranged therein, wherein the insert nut has been installed in the component.

FIG. 9 is a cross-sectional side view along section line 9-9 in FIG. 8.

FIG. 10 is a detailed view of FIG. 9.

### DETAILED DESCRIPTION

The present disclosure is related to providing metallic threads in soft or malleable materials and, more particularly, to insert nuts utilizable to provide metallic threads in soft or malleable materials and that have inhibit backing out and relative rotation.

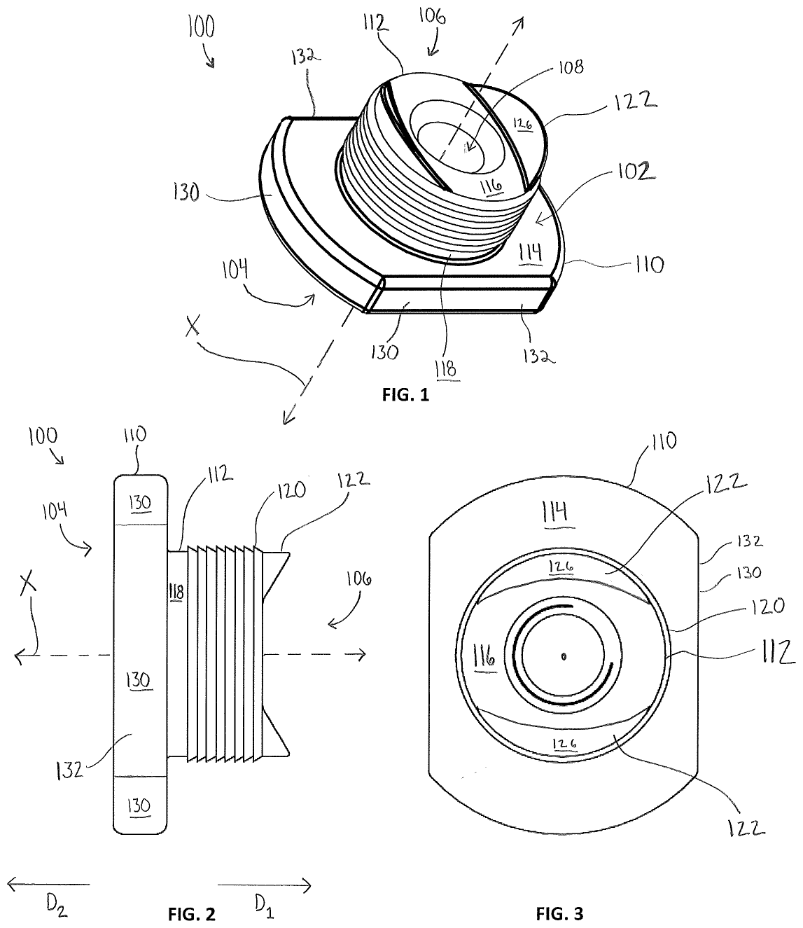

FIGS. 1-3 illustrate an exemplary insert nut 100, according to one or more embodiments of the present disclosure. The depicted insert nut 100 is just one example insert nut that can suitably incorporate the principles of the present disclosure. Indeed, many alternative designs and configurations of the insert nut 100 may be employed, without departing from the scope of this disclosure.

FIG. 1 shows an isometric view of the insert nut 100, according to one or more embodiments of the present disclosure. FIG. 2 and FIG. 3 show side and top views, respectively, of the insert nut 100 of FIG. 1. As illustrated, the insert nut 100 includes a body 102 that extends along a longitudinal axis X, from a bottom end 104 of the insert nut 100 to a top end 106 of the insert nut 100, and a threaded bore 108 extending along the longitudinal axis X through the body 102. The threaded bore 108 may have various thread configurations depending on the particular end use application in which the insert nut 100 is to be utilized, for example, depending on the type of fastener to be mounted within the threaded bore 108.

The insert nut 100 includes a flanged head 110 and a pilot 112 extending from a top surface or shoulder 114 of the flanged head 110.

The pilot 112 includes a top surface 116 and a lateral surface 118. The top surface 116 is positioned proximate to the top end 106 of the insert nut 100, and the lateral surface 118 comprises the sides of the pilot 112 extending around a circumference of the pilot, 112 radially outward from the longitudinal axis X.

A plurality of rings 120 are arranged on the lateral surface 118 of the pilot 112. Various numbers of the rings 120 may be provided, and they may be provided in various arrangements. Here, there are eight (8) of the rings 120 provided on the lateral surface 118. However, more or less of the rings 120 may be provided. Also in the illustrated example, the rings 120 are evenly distributed relative to each other, but they may be provided in various other even, uneven, or partially uneven arrangements. The rings 120 may have geometries that inhibit pulling or backing out of the insert nut 100 when installed in a soft or malleable material and/or the rings 120 may have geometries that facilitate installation of the insert nut 100 into the soft or malleable material. As exemplified in FIG. 2, the rings 120 may have triangular geometries when evaluated in cross-section, and such triangular geometry may facilitate insertion of the insert nut 100 into the soft or malleable material in an insertion direction D₁ while inhibiting backing out or removal of the insert nut 100 therefrom in a removal direction D₂.

A pair of tabs 122 are arranged on the top surface 116 of the pilot 112. The tabs 122 may each define an upper tab surface 126 that is angled relative to the top surface 116 of the pilot 112. In some examples, the upper tab surface 126 of the tabs 122 are arranged at 0 to 22° relative to the top surface 116 of the pilot 112; however, the upper tab surfaces 126 may be oriented at other angles outside of that range. Also, where more than one of the tabs 122 is provided, the upper tab surfaces 126 thereof may be oriented at the same or at different angles relative to the top surface 116 of the pilot 112.

Various numbers of the tabs 122 may be provided, and they may be provided in various arrangements. For example, in other examples, more or less than two (2) of the tabs 122 may be provided. Also in the illustrated example, the tabs 122 are evenly distributed relative to each other, on opposite sides of the top surface 116, but the tabs 122 may be provided in various other symmetrical, asymmetrical, or partially asymmetrical arrangements around the top surface 116. Regardless of how many of the tabs 122 are provided, the tabs 122 are configured to prevent pulling or backing out of the insert nut 100 from the soft or malleable material in the removal direction D₂ after the insert nut 100 has been inserted and installed therein via tooling. As described below, such tooling may be configured to deform or rivet the tabs 122 into engagement with the soft or malleable material. The tabs 122 may also inhibit relative rotation between the insert nut 100 and the soft or malleable material after assembled on the soft or malleable material. The tabs 122, together with the rings 120, provide the insert nut 100 with improved performance at inhibiting pushing or pulling out of the insert nut 100 from the soft or malleable material. Thus, the tabs 122 (together with the rings 120) and the flanged head 110 operate together to retain the insert nut within the soft or malleable material, with the tabs 122 and the rings 120 together inhibiting pushing or pulling out of the insert nut 100 in a first direction and the flanged head 110 inhibiting pushing or pulling out of the insert nut 100 in a second direction that is opposite to the first direction.

The flanged head 110 includes a lateral surface 130, which is normal to the top surface 114 and extends circumferentially around a periphery of the flanged head 110. The flanged head 110 may include various geometries and, in the illustrated example, a pair of flat surfaces or flats 132 are arranged on the lateral surface 130 of the flanged head 110. Here, the flats 132 are symmetrically arranged on opposing sides of the lateral surface 130 of the flanged head 110. However, in other examples, the flats 132 may be differently positioned and/or more or less than two (2) of the flats 132 may be provided. As described below, the flats 132 are configured to mate with an interior surface of channel provided in the soft or malleable material. Thus, the positioning of the flats 132 and/or the number of flats 132 utilized in any particular embodiment of the insert nut 100 may depend on the configuration of the soft or malleable material into which the insert nut 100 is to be secured.

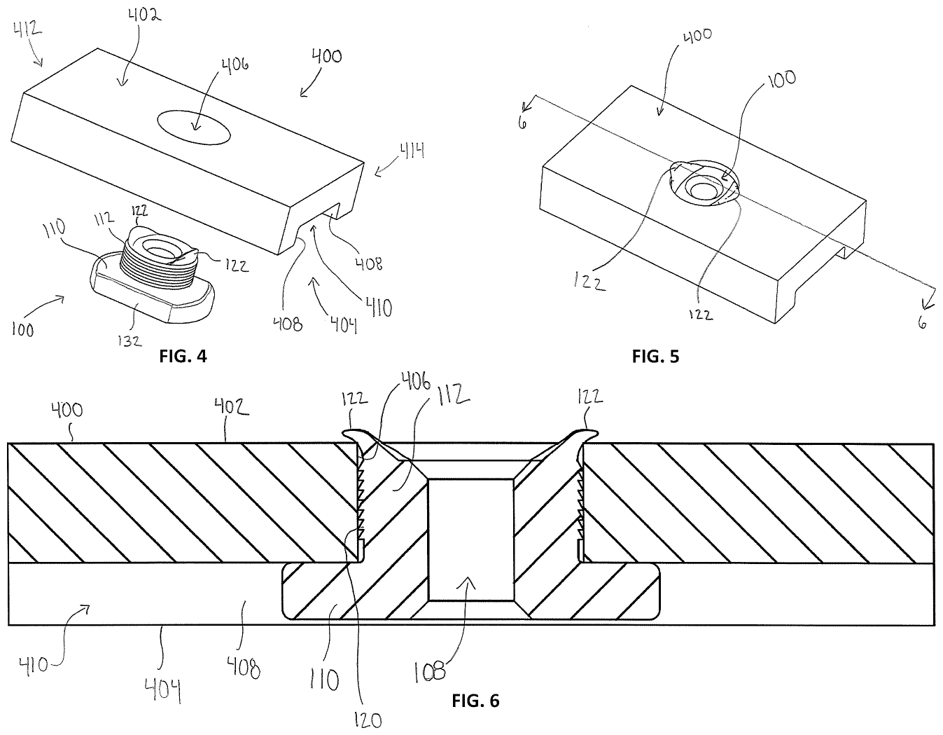

FIGS. 4-12 illustrate an example part or component 400 that may incorporate the principles of the present disclosure. The depicted component 400 is just one example component that can suitably incorporate the principles of the present disclosure. Indeed, many alternative designs and configurations of the component 400 may be employed, without departing from the scope of this disclosure.

The component 400 is configured to receive the insert nut 100, after which the insert nut 100 may be secured or anchored therein as described below. The component 400 comprises a soft or malleable material, such as a plastic or any other similar type of material. For example, the component may be an industrial grade automotive plastic, a glass-filled plastic/polymer, or any other mouldable composite material, etc. In addition, the insert nut 100 may be utilized in various end use applications. For example, the insert nut 100 may be utilized in automobile applications. In one such example, the component 400 is a portion of an automobile center console and the insert nut 100 is utilized to mount a transmission shifter of an automatic transmission. However, the insert nut 100 may be utilized in other automobile applications to mount other components to the component 400, whether the component 400 is part of an automobile center console or otherwise. It will be appreciated, however, that the insert nut 100 may be utilized in other non-automotive applications, and in these examples, the component 400 is a soft or malleable material associated in such other non-automotive applications.

FIG. 4 illustrates the component 400 and the insert nut 100 unassembled therefrom, according to one or more embodiments of the present disclosure. In the illustrated example, the component 400 includes an upper side 402 and a lower side 404. As previously mentioned, the component 400 is configured to receive the insert nut 100, which is illustrated unassembled from the lower side 404 of the component 400. Thus, the component 400 includes a hole 406 extending there-through, from the upper side 402 to the lower side 404. The hole 406 is configured to receive the pilot 112 of the insert nut 100. Accordingly, the hole 406 may have a diameter that corresponds to a diameter of the pilot 112.

Also, the lower side 404 of the component 400 is configured to receive the flanged head 110 of the insert nut 100 in a manner that inhibits relative rotation between the insert nut 100 and the component 400. In particular, the lower side 404 of the component 400 includes one or more flats or flat surfaces configured to abut a corresponding flat of the insert nut 100 (e.g., the flats 132 of the flanged head 110). In the illustrated example, a pair of flat surfaces 408 are arranged on the lower side 404 of the component 400. The flat surfaces 408 correspond with the flats 132 of the flanged head 110 of the insert nut 100 and inhibit relative rotation via interference there-between. Here, the flats 408 are provided within a channel 410 that is formed on the lower side 404 of the component 400. Here, the channel 410 extends from a first end 412 to a second end 414 of the component 400. Thus, the flat surfaces 408 in the illustrated example also extend between the first and second ends 412,414, though the flats 132 of the insert nut 100 may abut such flat surfaces 408 of the component 400 at locations proximate to the hole 406 depending on the length/size of the flats 132 provided on the flanged head 110 of the insert nut 100.

However, the one or more flats 408 of the component 400 may be differently formed or provided on the component 400. For example, rather than being provided in a channel 410 that is open at the first and second ends 412,414, the flats 408 may be provided in a recess that is surrounded by a lateral sidewall, and the lateral sidewall may include one or more flats configured to abut a corresponding flat of the insert nut 100 (e.g., the flats 132 of the flanged head 110). In these non-illustrated examples, the recess may have various sizes, with at least a portion thereof defining a flat configured to abut the corresponding flat of the insert nut 100 (e.g., the flats 132 of the flanged head 110). In one such example, the recess is sized larger than the flanged head 110, but with at least one flat surface for abutting one of the flats 132 of the insert nut 100; whereas, in other examples, the recessed is sized to approximately correspond to the size of the flanged head 110, such that the recess includes a pair of flats that abut the flats 132 of the flanged head 110 when the insert nut 100 is assembled within the component 400. It will be appreciated, however, that the one or more flats of the component 400 that are configured to abut the flats of the insert nut 100 may be provided or formed on the component 400 in a variety of different manners, without departing from the present disclosure.

FIG. 5 illustrates the insert nut 100 when partially assembled in the component 400, and FIG. 6 is a cross-sectional view of FIG. 5 along line section line 6-6, when the insert nut 100 is partially installed in the component 400 but before deformation of the tabs 122. These depictions illustrate the insert nut 100 sufficiently arranged within the hole 406 formed in the component 400, with the pilot 112 extending into the hole 406 of the component 400. When the insert nut 100 is assembled on the component as shown, the rings 120 on the lateral surface 118 of the pilot 112 engage the surface of the hole 406 formed in the component 400, which may inhibit (or help inhibit) backing out of the insert nut 100 as previously described. Also, when the pilot 112 is sufficiently positioned within the hole 406 of the component, the tabs 122 of the pilot 112 protrude outward from the hole 406, upward from the surface of the upper side 402 of the component 400. In addition, one of flat surfaces 408 arranged on the lower side 404 of the component 400 is shown being engaged by a corresponding one of flats 132 (obscured from view in FIGS. 5 and 6) arranged on the flanged head 110 of the insert nut 100, which may inhibit rotation of the insert nut 100 within the component 400.

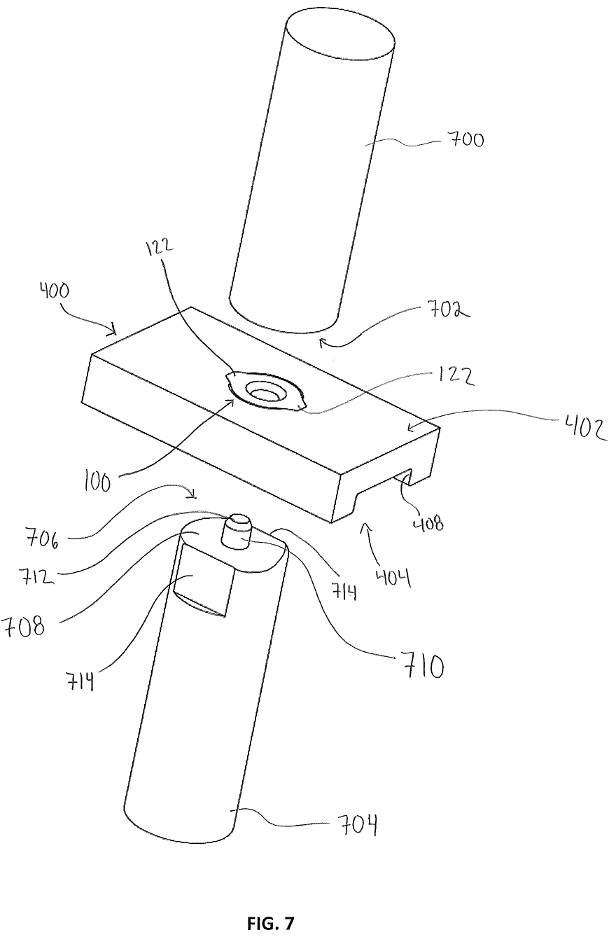

FIG. 7 illustrates an exemplary tool 700 that may be utilized to install the insert nut 100 into engagement with the component 400, according to one or more embodiments of the present disclosure. The depicted tool 700 is just one example tool that can suitably incorporate the principles of the present disclosure. Indeed, many alternative designs and configurations of the tool 700 may be employed, without departing from the scope of this disclosure.

After the insert nut 100 has been arranged in the hole 406 of the component, as described with reference to FIGS. 5 and 6, a user may press the tool 700 towards the upper side 402 of the component 400 to deform the tabs 122. Thus, the tool 700 may include an engagement or pressing surface 702 that is configured to contact the tabs 122 (when un-deformed) and deform the tabs 122 into the upper surface 402 of the component. As mentioned above, by deforming the tabs 122 into the component 400 as illustrated, the tabs 122 maintain engagement with the component 400 and inhibit backing out of the insert nut 100 from the component. In addition, deforming the tabs 122 into the material of the component 400 as shown may also inhibit relative rotation between the insert nut 100 and the component 400.

Despite being obscured from view in the illustrated examples, the engagement or pressing surface 702 may have various contour(s) and/or features. In some embodiments, for example, the engagement or pressing surface 702 of the tool 700 is substantially flat. In other embodiments, however, the tool 700 may have various contours and/or features configured to impart one or more characteristics to the tabs 122 when deformed into the upper surface 402 of the component 400. For example, the engagement or pressing surface 702 of the tool 700 may be configured to emboss or imprint various types of logos, designs, symbols, or other indicia into the tabs 122 to be visible after the tabs 122 have been deformed into the upper surface 402 of the component 400.

FIG. 7 also illustrates a positioning tool 704 configured to position the insert nut 100 within the channel 410 of the component 400, according to one or more embodiments of the present disclosure. The positioning tool 704 is just one example positioning tool that can suitably incorporate the principles of the present disclosure. Indeed, many alternative designs and configurations of the positioning tool 704 may be employed, without departing from the scope of this disclosure.

The positioning tool 704 is configured to hold the insert nut 100 and position the insert nut 100 relative to the component 400. In particular, the positioning tool 704 includes a positioning end 706 configured to hold the insert nut 100. In the illustrated example, the positioning end 706 includes a positioning face 708 and a location pin 710 extending from the positioning face 708. The positioning face 708 is configured to abut the flanged head 110 at the bottom end 104 of the insert nut 100 when the insert nut 100 is arranged on the positioning end 706. Here, the positioning face 708 is flat; however, the positioning face 708 may have various contours and/or features depending on the configuration of the flanged head 110 that sits thereon. The location pin 710 is configured to extend into the threaded bore 108 such that the flanged head 110 of the insert nut 100 may rest or sit upon the positioning face 708. The location pin 710 includes a chamfered end 712, which may facilitate placement of the insert nut 100 onto the location pin 710.

The location pin 710 may be configured to contact and/or grip the threaded bore 108 of the insert nut 100. Thus, the pilot may have various sizes and/or features. In some examples, the location pin 710 is not configured to grip the insert nut 100, and thus the threaded bore 108 of the insert nut 100 may slide easily over the location pin 710. In some examples, the location pin 710 and/or the positioning surface 708 (or another portion of the positioning tool 704) may be magnetized to hold the insert nut 100.

The positioning end 706 configured is also configured to fit within the component 400. In particular, the positioning end 706 may have one or more flats configured to abut the flats 408 of the component 400. Here, the positioning end 706 includes a pair of flats 714 that correspond with the flats 408 of the component 400. In this manner, the positioning end 706 may be inserted into the channel 410 of the component 400. The flats 714 of the positioning end 706 thus correspond with the flats 508 of the component and may thus have various other contours and/or features depending on the flats 408 and/or channel 410 of the component 400.

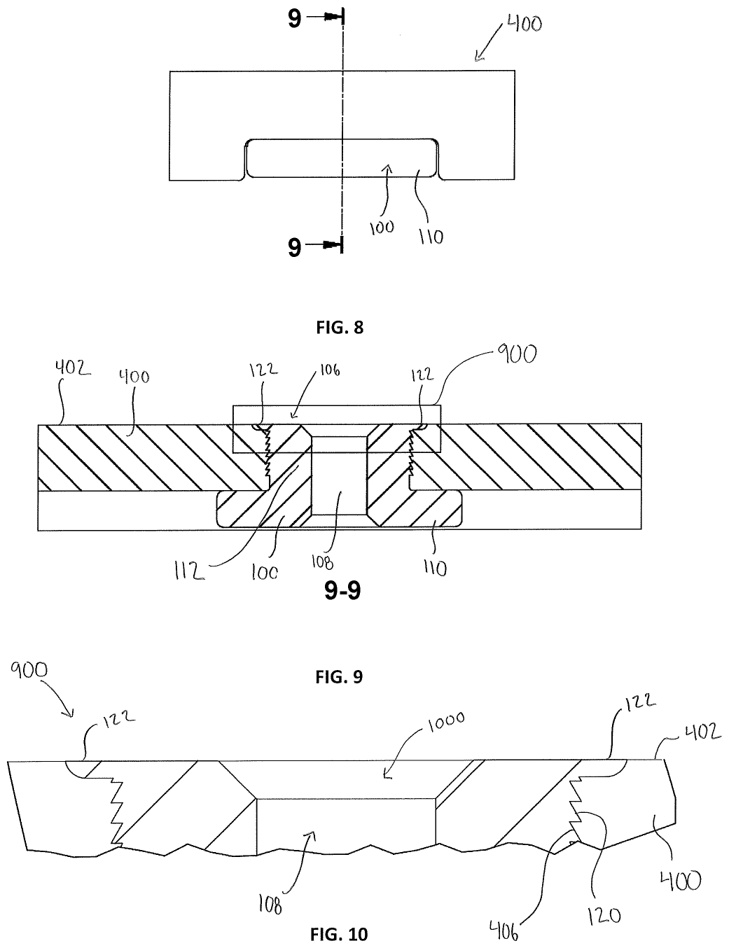

FIG. 8 illustrates the insert nut 100 assembled or installed within the component 400 after deformation of the tabs 122 (obscured from view). FIG. 9 is a cross-sectional side view along section line 9-9 in FIG. 8. In FIG. 9, the tabs 122 are shown deformed into engagement with the upper surface 402 of the component 400. FIG. 9 includes an engagement region 900, which has been drawn around a portion of the pilot 112 of the insert nut 100 proximate to the top end 106 of the insert nut 100 that extends within the hole 406 of the component proximate to the upper side 402 of the component 400.

FIG. 10 is a detailed view of the engagement region 900 of FIG. 9. In particular, FIG. 10 illustrates how the tabs 122 may be deformed into the upper side 402 of the component 400, and thereby inhibit backing out of the insert nut 100 from the component 400 and/or relative rotation between the insert nut 100 and the component 400. FIG. 10 also illustrates how the rings 120 arranged on the pilot 112 of the insert nut 100 may engage and deform the hole 406 formed in the component 400, and thereby inhibit backing out of the insert nut 100 from the component 400. Also, FIG. 10 illustrates an embodiment where the portion of the threaded bore 108 of the insert nut 100 proximate to the top end 106 of the insert nut 100 is configured to receive a fastener head (not shown). Here, the threaded bore 108 of the insert nut 100 extends into a chamfered bore 1000 at the top end 106 of the insert nut 100. The chamfered bore 1000 may have various geometries depending on the type of fastener or fastener head to be threaded within the threaded bore 108 of the insert nut 100. In some examples, the chamfered bore 1000 is configured such that the fastener head of the fastener threaded within the threaded bore 108 of the insert nut 100 is flush with the upper surface 402 of the component 400 or recessed underneath the upper surface 402 of the component 400 (i.e., towards the lower surface 404).

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

The use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. An insert nut comprising:
a body and a threaded bore extending through the body, wherein the body further comprises:
a flanged head having at least one flat;
a pilot extending from a flange surface of the flanged head; and
at least one tab arranged on an end of the pilot opposite from the flange surface, the at least one tab being deformable to inhibit backing out of the insert nut.

2. The insert nut of claim 1, wherein the end of the pilot defines a top surface and the at least one tab defines an upper tab surface that is angled relative to the top surface of the pilot.

3. The insert nut of claim 2, wherein the tab surface is oriented at an angle relative to the top surface of the pilot, and the angle is between 0 to 22°.

4. The insert nut of claim 1, wherein a plurality of rings are provided around a lateral surface of the pilot.

5. The insert nut of claim 1, wherein the body further includes a chamfered bore extending from the threaded bore at the end of the pilot.

6. The insert nut of claim 5, wherein the chamfered bore is configured to receive a fastener head such that the fastener head is flush with a component surface.

7. The insert nut of claim 1, wherein the body is configured to be assembled in a component.

8. The insert nut of claim 7, wherein the component is a soft or malleable material.

9. The insert nut of claim 7, wherein a hole is provided in the component for receiving the pilot.

10. The insert nut of claim 9, wherein a plurality of rings are provided around a lateral surface of the pilot and the plurality of rings are configured to engage a surface of the hole in the component.

11. The insert nut of claim 7, wherein the component has at least one flat arranged to engage the flat of the flanged head and thereby inhibit rotation of the body.

12. The insert nut of claim 11, wherein the at least one flat of the component is defined in a channel or recess formed in the component.

13. The insert nut of claim 7, wherein the at least one tab is configured to be deformed into the component via a tool.

14. The insert nut of claim 7, wherein the body is configured to be positioned in the component via a positioning tool.

15. The insert nut of claim 14, wherein the positioning tool includes a pilot configured to reference the threaded bore of the body.

16. The insert nut of claim 14, wherein the pilot of the positioning tool grips the body of the insert nut.

17. The insert nut of claim 16, wherein positioning tool includes a magnet configured to attract the body.

18. The insert nut of claim 14, wherein the positioning tool includes at least one flat configured to fit within a channel or recess of the component, the channel or recess of the component defining at least one flat corresponding with the flat of the positioning tool.

19. An insert nut assembly, comprising
a component having an upper side and a lower side, and a hole extending through the component from the upper side to the lower side; and
an insert nut arrangable within the hole of the component, the insert nut further comprising:
a flanged head having at least one flat arranged to engage a corresponding flat defined in the lower side of the component,
a pilot extending from a shoulder of the flanged head,
at least one tab arranged on an end of the pilot opposite from the shoulder, the at least one tab being deformable into the upper side of the component to inhibit backing out of the insert nut, and
a threaded bore extending through the flanged head and the pilot.

20. An insert nut assembly, comprising
a component having an upper side and a lower side, and a hole extending through the component from the upper side to the lower side;
an insert nut arrangable within the hole of the component, the insert nut further comprising:
a flanged head having at least one flat arranged to engage a corresponding flat defined in the lower side of the component,
a pilot extending from a shoulder of the flanged head,
at least one tab arranged on an end of the pilot opposite from the shoulder, and
a threaded bore extending through the flanged head and the pilot; and
tooling configured to deform the at least one tab of the insert nut into the upper side of the component to inhibit backing out of the insert nut.
